(19) United States
(12) Patent Application Publication
(10) Pub. No.: US 2014/0000002 A1
(43) Pub. Date: Jan. 2, 2014

(54) SOFTENED WATERPROOF MATERIAL FOR WATER SPORTS GARMENT

(71) Applicant: Heng-Wen Shiue, Yilan County (TW)

(72) Inventor: Heng-Wen Shiue, Yilan County (TW)

(73) Assignee: SHEI CHUNG HSIN IND. CO., LTD., Yilan County (TW)

(21) Appl. No.: 13/537,075

(22) Filed: Jun. 29, 2012

(51) Int. Cl. A41D 13/012; B32B 5/18; B32B 25/00; B32B 7/12

(52) U.S. Cl. 2/69; 428/317.1

(57) ABSTRACT

A softened waterproof material for water sports garments is provided. The outer surface of the softened waterproof material comprises a layer of soft waterproof coating on the outer surface of the water sports garments. The soft waterproof coating comprises styrene-ethylene/butylene-styrene (SEBS) block copolymer, and a softener.

### BACKGROUND

1. Technical Field

The disclosure relates to water sports garment. More particularly, the disclosure relates to a softened elastic water sports garment.

2. Description of Related Art

Waterproof wears are commonly used in water sports, such as diving, surfing and canoeing. The waterproof wears used in water sports must have the characteristics of lightweight, elasticity, buoyancy, being easy to put on and take off and tactual comfort of skin contact in order to allow the wearer to keep warm and to move without substantial constraints.

The most commonly used material for waterproof wears is a foamed rubber sheet sandwiched by two layers of fabrics. However, the water absorbing capacity of the dry material is still needed to be decreased to decrease the wet weight of the waterproof wears.

### SUMMARY

Accordingly, in one aspect, the present invention is directed to a softened waterproof material consisting essentially of a foamed rubber sheet, two layers of rubber glue, two layers of elastic fabric, and a layer of soft waterproof coating. The two layers of rubber glue are disposed on opposite surfaces of the foamed rubber sheet. The two layers of elastic fabric are disposed on outer surfaces of the two layers of the rubber glue. The soft waterproof coating is disposed on an outer surface of one of the elastic fabric, and the soft waterproof coating comprises 100 parts by weight of styrene-ethylene/butylene-styrene (SEBS) block copolymer, and 50-300 parts by weight of a softener.

According to an embodiment, the softener comprises a paraffinic distillate oil.

According to yet another embodiment, the soft waterproof coating further comprises a pigment.

According to yet another embodiment, the elastic modulus of the softened waterproof material is 0.7-1.5 Kg/cm².

According to yet another embodiment, the water absorption amount of the softened waterproof material is 40-70 g/m².

In another aspect, this invention is also directed to a water sports garment comprises the softened waterproof material above.

The forgoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Many of the attendant features will be more readily appreciated as the same becomes better understood by reference to the following detailed description considered in connection with the accompanying drawings.

### BRIEF DESCRIPTION OF THE DRAWINGS

FIG. 1 is a cross-sectional diagram of a softened waterproof material for water sports garment according to an embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### Softened Waterproof Material For Water Sports Garments

Accordingly, in one aspect, a softened waterproof material for water sports garments is provided. The softened waterproof material has a lower water absorption amount to decrease the wet weight thereof. According to an embodiment, the water absorption amount of the softened waterproof material is 40-70 g/m².

The softened waterproof material also has a lower elastic modulus for being easily worn on and taken off. “Elastic modulus” is the mathematical description of an object or substance's tendency to be deformed elastically (i.e., non-permanently) when a force is applied to it. The elastic modulus of an object is defined as the slope of its stress-strain curve in the elastic deformation region. According to an embodiment, the elastic modulus of the softened waterproof material is 0.7-1.5 Kg/cm².

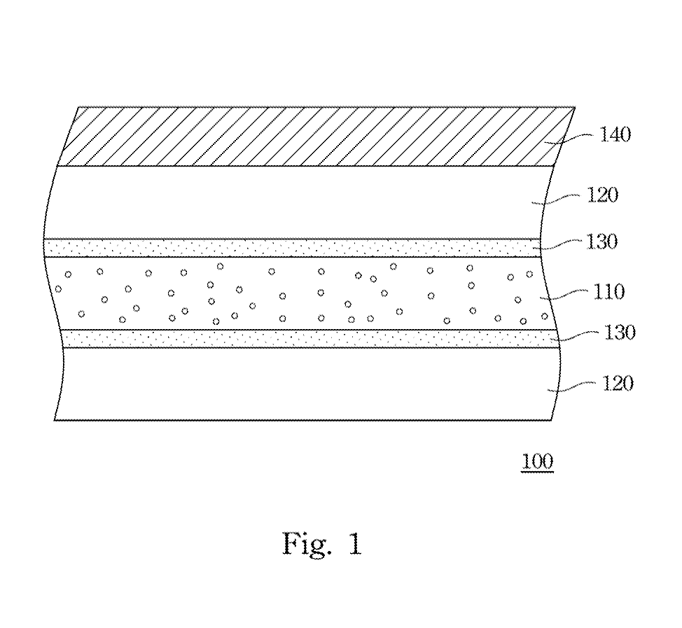

FIG. 1 is a cross-sectional diagram of a softened waterproof material for water sports garments according to an embodiment of this invention. In FIG. 1, the softened waterproof material 100 basically includes a foamed rubber sheet 110 sandwiched by two layers of elastic fabric 120. Rubber glue layers 130 are used to bind the foamed rubber sheet 110 and the elastic fabric layers 120. In addition, a soft waterproof coating 140 is coated on one of the elastic fabric layer 120, and the soft waterproof coating 140 can penetrate the slits of the elastic fabric layer 120 to surround the fibers of the elastic fabric layer 120.

The elastic fabric layer 120 is a woven fabric and made from about 21% of spandex fibers and about 79% of synthetic fibers to match the elasticity of the foamed rubber sheet. Both the spandex fibers and the synthetic fibers are 10-40 denier, and preferably 10-20 denier for making the elastic fabric layer 120 lighter and thinner. The synthetic fibers can be polyamide fibers or polyester fibers. Therefore, the thickness of the elastic fabric layer 120 can be about 0.2-0.5 mm, the weight per unit area can be 40-80 g/m², and the elasticity can be 200%-350% on both the vertical and horizontal directions of the elastic fabric layer 120.

The composition of the rubber glue layers 130 comprises 100 parts by weight of a synthetic elastomer, 4-7 parts by weight of a vulcanizing agent, and 0.5-1.5 parts by weight of an antioxidant agent, for example. The synthetic elastomer above can be polychloroprene, for example. The vulcanizing agent for vulcanizing the synthetic elastomer can be MgO, ZnO or a combination thereof, for example. The antioxidant agent for preventing the oxidation of the synthetic elastomer can be (3,5-di-t-butyl-4-hydroxy-phenyl) carboxylate or a derivative of (3,5-di-t-butyl-4-hydroxy-phenyl) carboxylate, for example.

The composition of the soft waterproof coating 140 comprises 100 parts by weight of styrene-ethylene/butylene-styrene (SEBS) block copolymer, and 50-300 parts by weight of a softener.

The SEBS is the main component of the soft waterproof coating 140, and often is a triblock copolymer having polystyrenes segments on the ends and a rubber segment in the center. The ratio of polystyrnene segments/rubber is about 13/87-31/69. The glass transition temperature of the rubber segment is below −50 ° C., so they will retain their rubbery properties at low temperature. The softener comprises a paraffinic distillate oil, for example. Since the polystyrene segments of the SEBS can be solvated by the paraffinic distillate oil, the polystyrene segments of SEBS is softened and free to move. Therefore, the softener can soften the SEBS block copolymer, increase the elastic modulus of the SEBS block copolymer, and increase the adhesive force of the SEBS block copolymer to the fabric layer 120.

According to another embodiment, the initial composition of the soft waterproof coating 140 can further comprise a pigment to give various colors of the soft waterproof coating 140. The added amount of the pigment is about 1-10 parts by weight.

According to an embodiment, the initial composition of the soft waterproof coating 140 can be uniformly dissolved or dispersed in an organic solvent, such as xylene, toluene, methyl ethyl ketone (MEK) or ethyl acetate (EAC), to prepare a coating solution.

In another aspect, a water sports garment comprises the softened waterproof material above is also provided. The water sports garment can be made by combining sheets of the softened waterproof material to decrease the water absorption amount and thus the wet weight, and maintain a low elastic modulus for being easily worn on and taken off by a user.

### Comparison Tests

Some comparison tests for water absorption amount, elastic modulus 60%, and breaking strength were made. The tested samples and results are listed in Table 1 below.

TABLE 1
Results of some comparison tests.

| | | Sample | | | |
|---|---|---|---|---|---|
| | | 1 | 2 | 3 | 4 |
| Laminated | First fabric layer | Yes | Yes | Yes | Yes |
| structure | Foamed rubber sheet¹ | Yes | Yes | Yes | Yes |
| | Second fabric layer | — | Yes | Yes | Yes |
| | Waterproof coating | — | — | CR | SEBS³ |
| | | | | rubber² | |

| | | | | |
|---|---|---|---|---|
| Water absorption amount (g/m²) | 61 | 149 | 61 | 61 |
| Elastic Modulus 60% (kg/cm²)⁴ | 1.6 | 1.3 | 3 | 1.5 |
| Breaking strength (kg/in)⁵ | 23-29 | 40-55 | 41-57 | 41-57 |

¹3 mm thick
²CR rubber is polychloroene rubber
³SEBS is the soft waterproof coating 140 described above, wherein the initial composition of the coating is 100 parts by weight of SEBS block copolymer, and 200 parts by weight of paraffinic distillate oil.
⁴The elastic modulus was measured when the length L of the tested sample was elongated to 1.6 L.
⁵The tested sample sizes were all 15 cm × 15 cm. The width of the clamps was 2.54 cm. The pulling rate for the tensile test was 300 mm/min.

Comparing samples 1 and 2 in Table 1, the water absorption amount was significantly increased by adding the second fabric layer in sample 2 (from 61 g/m² to 149 g/m²), and the breaking strength was also significantly increased by adding the second fabric layer in sample 2 (from 23-29 kg/in to 40-55 kg/in). However, the elastic modulus is decreased a little bit (from 1.6 kg/cm² to 1.3 kg/cm²). Therefore, the second fabric layer can increase both the water absorption amount and the breaking strength, but decrease the elastic modulus.

In order to decrease the water absorption amount of the sample 2, a waterproof CR rubber coating was coated on the outer surface of the second fabric layer to make the sample 3. The water absorption amount was indeed significantly decreased by coating the CR rubber coating (from 149 g/m² to 61 g/m²), but the elastic modulus was significantly increased by the CR rubber coating (from 1.3 kg/cm² to 3 kg/cm²). Accordingly, if sample 3 is made into a water sports garment, it will be hardly worn on and taken off by a user.

Accordingly, for finding a waterproof coating that can decrease the water absorption amount and not significantly increase the elastic modulus, the inventors finally try the SEBS coating after many tries. Comparing samples 3 and 4, only the elastic modulus was changed, the water absorption amount and the breaking strength were maintained the same. The elastic modulus was significantly decreased by changing the coating from CR rubber coating of sample 3 to SEBS coating of sample 4 (from 3 kg/cm² to 1.5 kg/cm²). Comparing samples 2 and 4, the elastic modulus were quite close, 1.3 kg/cm² v. 1.5 kg/cm².

In light of foregoing, the SEBS coating has the advantage of being capable of maintaining both the low elastic modulus and high breaking strength, but decreasing the water absorption amount of a single foamed rubber sheet sandwiched by two elastic fabric layers. Therefore, a water sports garment comprises the softened waterproof material above can have the advantages of low water absorption amount to decrease the wet weight and low elastic modulus for being easily worn on and taken off by a user.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A softened waterproof material consisting essentially of:
a foamed rubber sheet;
two layers of rubber glue disposed on opposite surfaces of the foamed rubber sheet;
two layers of elastic fabric on outer surfaces of the two layers of the rubber glue, wherein the vertical and horizontal elasticity of the elastic fabric is 200%-350%; and
a layer of soft waterproof coating on an outer surface of one of the elastic fabric, wherein the soft waterproof coating comprises 100 parts by weight of styrene-ethylene/butylene-styrene (SEBS) block copolymer, and 50-300 parts by weight of a softener.

2. The softened waterproof material of claim 1, wherein the softener comprises a paraffinic distillate oil.

3. The softened waterproof material of claim 1, wherein the soft waterproof coating comprises a pigment.

4. The softened waterproof material of claim 1, wherein a elastic modulus of the softened waterproof material is 0.7-1.5 Kg/cm².

5. The softened waterproof material of claim 1, wherein a water absorption amount of the softened waterproof material is 40-70 g/m².

6. The softened waterproof material of claim 1, wherein a thickness of the elastic fabric is 0.2-0.5 mm.

7. The softened waterproof material of claim 1, wherein a weight per unit area of the elastic fabric is 40-80 g/m².

8. A water sports garment, comprising:
a softened waterproof material of claim 1, wherein the layer of the soft waterproof coating is located on the outer surface of the water sports garment.

9. The water sports garment of claim 8, wherein the softener comprises paraffinic distillate oil.

10. The water sports garment of claim 8, wherein the soft waterproof coating comprises a pigment.

11. The water sports garment of claim 8, wherein a elastic modulus of the softened waterproof material is 0.7-1.5 Kg/cm².

12. The water sports garment of claim 8, wherein a water absorption amount of the softened waterproof material is 40-70 g/m².

13. The water sports garment of claim 8, wherein a thickness of the elastic fabric is 0.2-0.5 mm.

14. The water sports garment of claim 8, wherein a weight per unit area of the elastic fabric is 40-80 g/m².
